(19) United States
(12) Patent Application Publication
(10) Pub. No.: US 2009/0168422 A1
(43) Pub. Date: Jul. 2, 2009

(54) ILLUMINATION DEVICE

(75) Inventors: MEI-CHIH CHIU, Chu-Nan (TW); CHUN-TA CHEN, Chu-Nan (TW); CHIH-MING LAI, Chu-Nan (TW); CHIN-FENG TSENG, Chu-Nan (TW); PING-YU CHEN, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/177,424

(22) Filed: Jul. 22, 2008

(30) Foreign Application Priority Data
Dec. 28, 2007 (CN) 200710203524.0

(51) Int. Cl. F21V 21/30; F21V 21/14

(52) U.S. Cl. 362/249.03; 362/249.1

(57) ABSTRACT

An exemplary illumination device includes a number of illuminants and a number of pivoting shafts. Each of the illuminants includes a casing and a light source received in the casing. The pivoting shafts pivotedly connect the casing. Each of the pivoting member is coupled to each two neighboring illuminants.

### BACKGROUND

1. Technical Field

The present invention relates to illumination device, and particularly to an illumination device that is capable of large-area illumination.

2. Description of Related Art

Various types of illumination devices are generally well known in the art. Self-contained illumination devices, such as incandescence lamps, fluorescent lamps and halogen lamps, generally have structures with suitable volumes so as to facilitate conveying these illumination devices.

However, such structures of the illumination devices limit the brightness and the illumination area of the illumination devices at one time. It is not satisfying to use theses illumination devices in certain areas, such as stadiums and stages, where a large-area illumination is needed. Typically, in order to increase the area that can be illuminated by the light emitted by the illumination devices, the volume of the illumination devices generally increases to receive a number of light sources and corresponding components therein. The large volumes of the illumination devices cause an increase in difficulty of conveying the illumination devices.

What is needed, therefore, is an illumination device that is capable of large-area illumination, which can overcome the above-mentioned problems.

### SUMMARY

One present embodiment provides an illumination device includes a number of illuminants and a number of pivoting shafts. Each of the illuminants includes a casing and a light source received in the casing. The pivoting shafts pivotedly connect the casings. Each of the pivoting shafts is coupled to each two neighboring illuminants.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic exploded view of an illumination device according to a first embodiment.

FIG. 2 is a schematic assembled view of the illumination device shown in FIG. 1.

FIG. 3 is a schematic, cross-sectional view of an illuminant of the illumination device shown in FIG. 1.

FIG. 4 is a schematic exploded view of an illumination device according to a second embodiment.

FIG. 5 is a schematic assembled view of the illumination device shown in FIG. 4.

FIG. 6 is a schematic exploded view of an illumination device according to a third embodiment.

FIG. 7 is a schematic assembled view of the illumination device shown in FIG. 6.

FIG. 8 is a schematic assembled view of an illumination device according to a fourth embodiment.

### DETAILED DESCRIPTION OF THE EMBODIMENTS

Embodiments will now be described in detail below and with reference to the drawings.

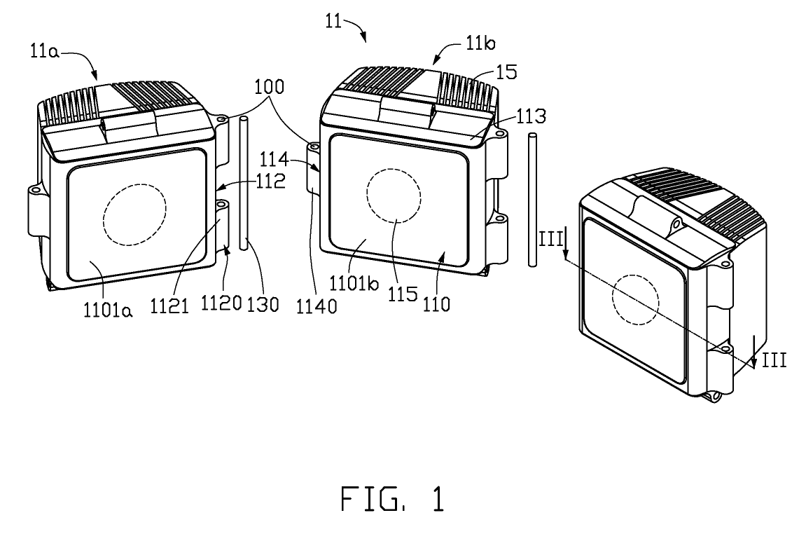

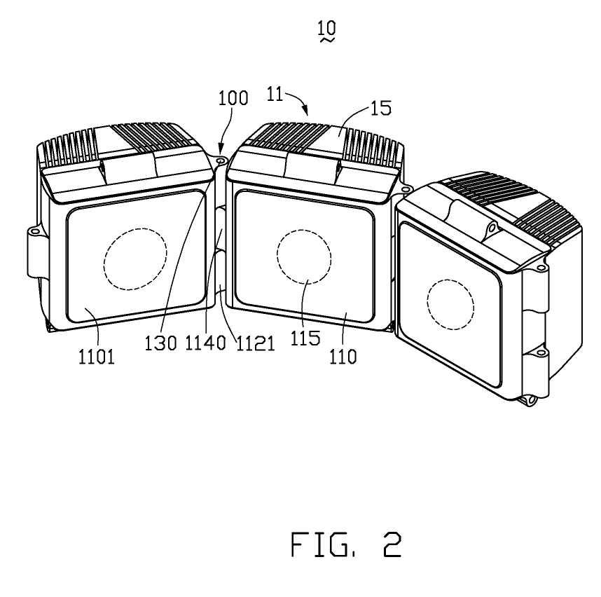

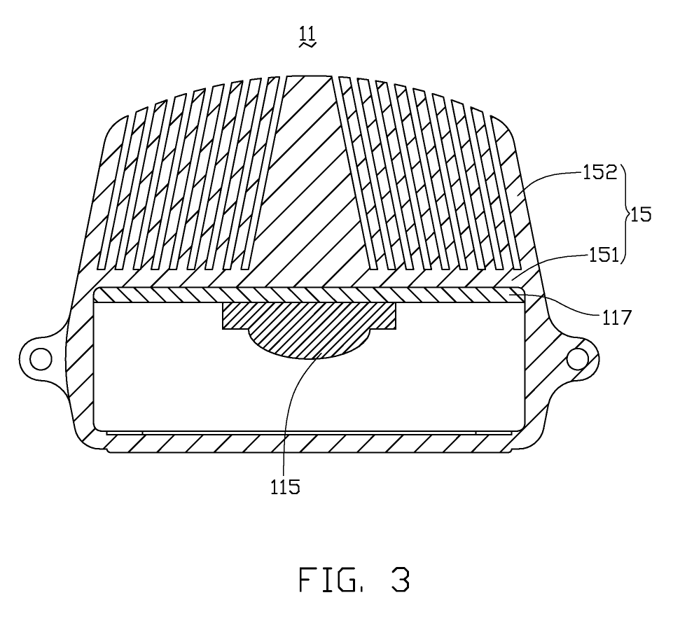

Referring to FIG. 1, FIG. 2 and FIG. 3, an exemplary illumination device 10 according to a first embodiment is shown. The illumination device 10 includes a number of illuminants 11 and a number of pivoting shafts 130 pivotedly connecting the illuminants 11.

Each of the illuminants 11 has a casing 113 and a light source 115 received in the casing 113. The casing 113 includes a front panel 110, a first sidewall 112 and a second sidewall 114 on an opposite side of the casing 113 to the first sidewall 112. The front panel 110 defines a light emitting surface 1101 and is made of a transparent material so that a light beam from the light source 115 can pass through and emit from the front panel 110. The light source 115 can be selected from the group consisting of a light emitting diode, an incandescence lamp, a fluorescent lamp, a gas discharge lamp, an infrared ray lamp and a halogen lamp.

In the present embodiment, a heat sink device 15 is mounted on the casing 113 for dissipating heat from the light source 115 and other electronic components received in the casing 113. In detail, referring to FIG. 3, the heat sink device 15 includes a thermally conductive base 151 and a number of fins 152 extending from the thermally conductive base 151. The thermally conductive base 151 is connected to the rear of the casing 113, and is integrated with the first sidewall 112 and the second sidewall 114. The thermally conductive base 151 is contacted with a printed circuit board 117 for mounting the light source 115 thereon. Thus, heat form the light source 115 and the printed circuit board 117 can be transferred to the thermally conductive base 151 and dissipated through the fins 152.

Further, each of the casing 113 contains a first pivoting portion 1120 formed on the first sidewall 112 and a second pivoting portion 1140 formed on the second sidewall 114. The first pivoting portion 1120 of one of the illuminants 11 (e.g., a first illuminant 11a) is pivoted with the second pivoting portion 1140 of another one of the illuminants 11 (e.g., a second illuminant 11b) via the pivoting shaft 130. The first illuminant 11a and the second illuminant 11b are two neighboring illuminants 11.

In the present embodiment, the first pivoting portion 1120 includes two pivoting parts 1121, and the second pivoting portion 1140 is located between the two pivoting parts 1121. Advantageously, two ends of the second pivoting portion 1140 are contacted with the two pivoting parts 1121, respectively. The two pivoting parts 1121 and the second pivoting portion 1140 each define a through hole 100 therein. The pivoting shaft 130 is received in the through holes 100 for connecting the first pivoting portion 1120 and the second pivoting portion 1140. As a result, the first illuminant 11a is pivoted with the second illuminant 11b via the pivoting shaft 130. The light emitting surface 1101a of the first illuminant 11a and the light emitting surface 1101b of the second illuminant 11b are located on a side of the illumination device 10. The light emitting surface 1101a of the first illuminant 11a can be rotatable around a rotating axis (i.e., the corresponding pivoting shaft 130) relative to the light emitting surface 1101b of the first illuminant 11b, thereby adjusting the structure of the illumination device 10. In addition, the first illuminant 11a can be slidable and linearly movable relative to the second illuminant 11b along the rotating axis (i.e., the corresponding pivoting shaft 130).

It is noted that a number of illuminants 11 can be assembled in such manner as described above. Each two neighboring illuminants 11 are pivotedly coupled to each other via the pivoting shafts 130. The pivoting shafts 130 are parallel to each other, and thus the rotating axes of the illuminants 11 are parallel to each other. The light emitting surface 1101 of one such illuminant 11 is rotatable around the rotating axis (i.e., the corresponding pivoting shaft 130) relative to that of the other neighboring such illuminant 11, thereby adjusting the structure of the illumination device 10. Referring to FIG. 2, three illuminants 11 are pivotedly coupled to each other via two pivoting shafts 130 and arranged in an arc-shaped to form the illumination device 10 having a large-area illumination. In addition, the illumination device 10 has a function of converging light, thereby increasing brightness of the illumination device 10.

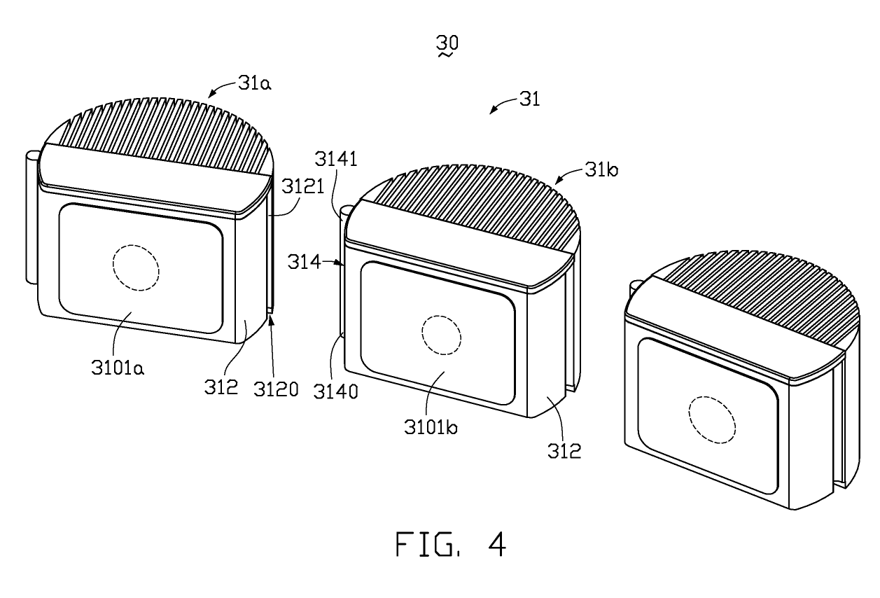

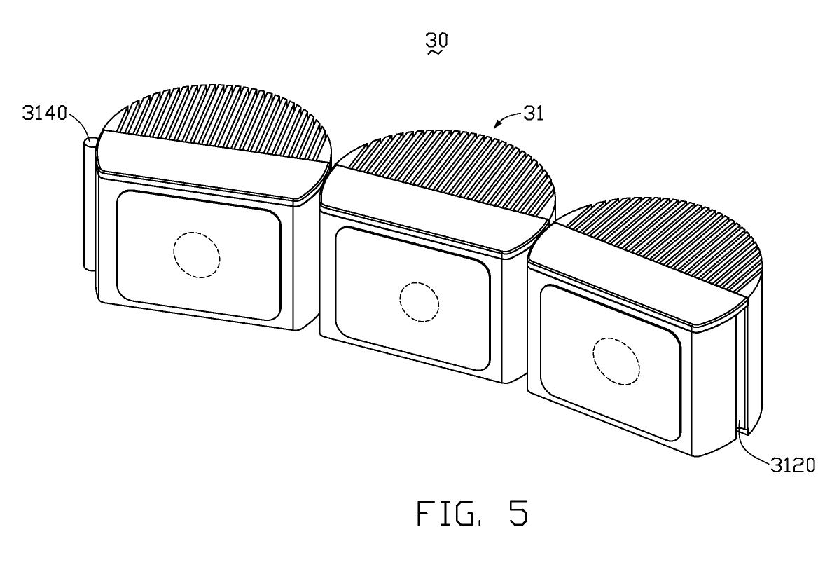

Referring to FIG. 4 and FIG. 5, an exemplary illumination device 30 according to a second embodiment is shown. The illumination device 30 is similar to the illumination 10 in the first embodiment.

Each of the casing 313 includes a first pivoting portion 3120 formed on a first sidewall 312 and a second pivoting portion 3140 formed on a second sidewall 314. The illuminants 31 include a first illuminant 31a and a second illuminant 31b. The first illuminant 31a and the second illuminant 31b are neighboring. A pivoting shaft 3141 is connected to the second pivoting portion 3140 and the first pivoting portion 3120 defines a recess 3121 coupled to the pivoting shaft 3141. The pivoting shaft 3141 is received in the recess 3121 so that the pivoting shaft 3141 can rotate in the recess 3121. Advantageously, the pivoting shaft 3141 is in a configuration of cylinder. As a result, the first illuminant 31a is pivoted with the second illuminant 31b. The light emitting surface 3101a of the first illuminant 31a and the light emitting surface 3101b of the second illuminant 31b are located on a side of the illumination device 30. A light emitting surface 3101a of the first illuminant 31a can be rotatable around a rotating axis (i.e., the corresponding pivoting shaft 3141) relative to the light emitting surface 3101b of the second illuminant 31b, thereby adjusting the structure of the illumination device 10. In addition, the first illuminant 31a can be slidable and linearly movable relative to the second illuminant 31b along rotating axis (i.e., the corresponding pivoting shaft 3141). Referring to FIG. 5, three illuminants 31 are pivotedly coupled to each other in such manner as described above. The pivoting shafts 3141 are parallel to each other. The three illuminants 31 are arranged in an arc-shaped to form the illumination device 30 having a large-area illumination. In the present embodiment, a first pivoting portion 3120 of one illuminant 31 and a second pivoting portion 3140 of another one illuminant 31 are free. The one illuminant 31 and the another one illuminant 31 are respectively located two opposite sides of the illumination device 30. The free first pivoting portion 3120 and the free second pivoting portion 3140 can pivot with other illuminants 31.

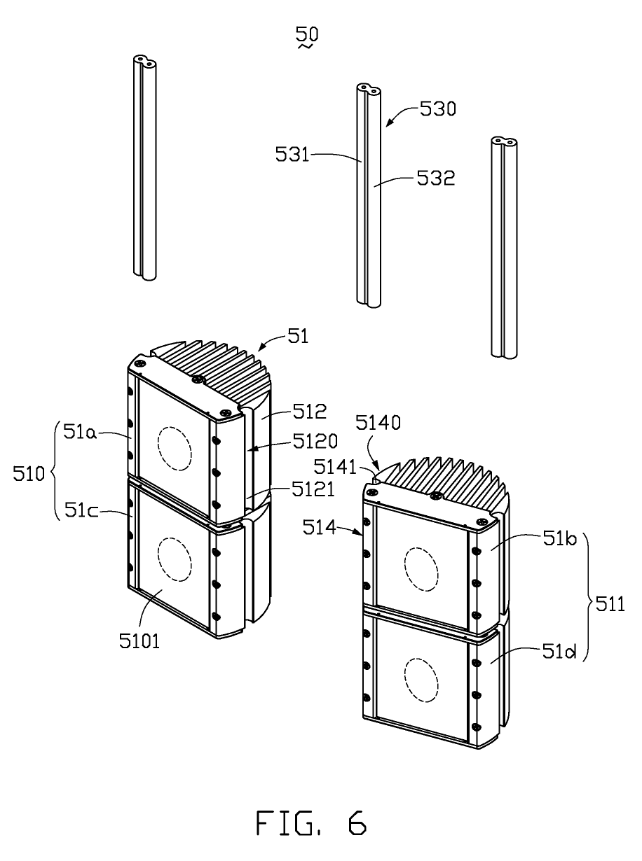

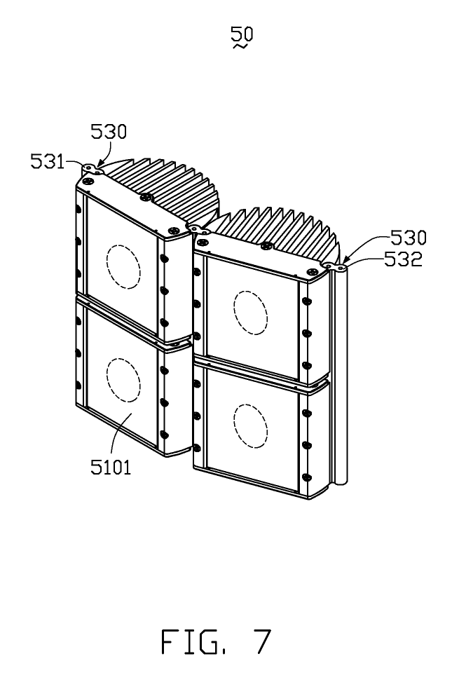

Referring to FIG. 6 and FIG. 7, an exemplary illumination device 50 according to a third embodiment is shown. The illumination device 50 is similar to the illumination 10 in the first embodiment.

Each of the casing 513 includes a first pivoting portion 5120 formed on the first sidewall 512 and a second pivoting portion 5140 formed on a second sidewall 514. The pivoting shaft 530 comprises a first shaft 531 and a second shaft 532 parallel to and connected to the first shaft 531. The first pivoting portion 5120 defines a first recess 5121 coupled to the first shaft 531 and the second pivoting portion 5140 defines a second recess 5141 coupled to the second shaft 532. The first shaft 531 is received in the first recess 5121 and the second shaft 532 is received in the second recess 5141. The illuminants 51 include a first illuminant 51a and a second illuminant 51b. The first illuminant 51a and the second illuminant 51b are neighboring. As a result, the first pivoting portion 5120 of the first illuminant 51a is pivoted with the second pivoting portion 5140 of the second illuminant 51b via the pivoting shaft 530.

In the present embodiment, a number of the illuminants 51 are arranged in an array. In detail, the first illuminant 51a is placed on a third illuminant 51c to form a first light source unit 510, and the second illuminant 51b is placed on a fourth illuminant 51d to form a second light source unit 511. The first shaft 531 has an adequate length so as to be received in the first recesses 5121 of the first illuminant 51a and the third illuminant 51c simultaneously. The second shaft 532 has an adequate length so as to be received in the second recesses 5141 of the second illuminant 51b and the fourth illuminant 51d simultaneously. As a result, the first illuminant 51a, the second illuminant 51b, the third illuminant 51c and the fourth illuminant 51d are arranged in an array and pivoted together. The light emitting surfaces 5101 of the first illuminant 51a, the second illuminant 51b, the third illuminant 51c and the fourth illuminant 51d are located on a side of the illumination device 50. A light emitting surface 5101 of the first illuminant 51a and that of the third illuminant 51c can be rotatable around a rotating axis (i.e., the corresponding pivoting shaft 530) relative to that of the second illuminant 51b and that of the fourth illuminant 51d, thereby adjusting the structure of the illumination device 10. In addition, the first light source unit 510 are slidable and linearly movable relative to the second light source unit 511 along the rotating axis (i.e., the corresponding pivoting shaft 530). In the present embodiment, a second shaft 532 of one pivoting shaft 530 and a first shaft 531 of another pivoting shaft 530 are free. The one pivoting shaft 530 and the another one pivoting shaft 530 are respectively located two opposite sides of the illuminant array.

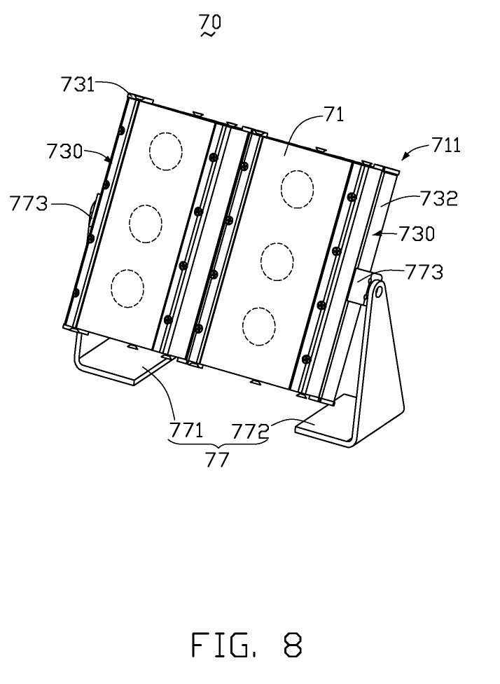

Referring to FIG. 8, an exemplary illumination device 70 according to a fourth embodiment is shown. The illumination device 70 is similar to the illumination 50 in the third embodiment. The illumination device 70 includes a number of illuminants 71 arranged in an array and assembled in a manner described in the third embodiment to form an illuminant array 711, and further includes a supporting member 77. The illuminant array 711 is rotatablely mounted on the supporting member 77.

In the present embodiment, a second shaft 732 of one pivoting shaft 730 and a first shaft 731 of another pivoting shaft 730 are free. The one pivoting shaft 730 and the another one pivoting shaft 730 are respectively located two opposite sides of the illuminant array 711. The supporting member 77 contains a first supporting base 771 and a second supporting base 772 facing to the first supporting base 771. The first supporting base 771 is connected with a second shaft 732 of the one pivoting shaft 730 via a rotating member 773. The second supporting base 772 is connected with a first protrusion 731 of the another connecting shaft 730 via another rotating member 773. Each of the rotating members 773 can rotate around a connecting line of the rotating members 773 mounted on the first supporting base 771 and the second supporting base 772, respectively, thereby forming an axis. The axis is substantially perpendicular to the pivoting shaft 730. Thus, the illuminant array 711 is rotatablely mounted on the first supporting base 771 and the second supporting base 772 and rotatable around the axis relative to the supporting member 77. It is noted that the supporting member 77 can be designed in other possible structures.

While certain embodiment has been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An illumination device, comprising:
a plurality of illuminants, each of the plurality of illuminants comprising a casing and a light source received in the casing; and
a plurality of pivoting shafts pivotedly connecting the casings, each of the pivoting shafts being coupled to each two neighboring illuminants.

2. The illumination device as claimed in claim 1, wherein each casing comprises a first sidewall and a second sidewall on an opposite side of the casing to the first sidewall, a first pivoting portion formed on the first sidewall, a second pivoting portion formed on the second sidewall, the first pivoting portion of the one of each two neighboring illuminants hinged to the second pivoting portion of the other neighboring such illuminant.

3. The illumination device as claimed in claim 2, wherein the first pivoting portion and the second pivoting portion each define a through hole therein for extension of the shaft therethrough.

4. The illumination device as claimed in claim 3, wherein the first pivoting portion comprises two first pivoting parts, and the second pivoting portion is located between the two first pivoting parts.

5. The illumination device as claimed in claim 2, wherein one such pivoting shaft coupled to each two neighboring illuminants is connected to the first pivoting portion, the second pivoting portion has a recess coupled to the one such pivoting shaft, and the one such pivoting shaft is received in the recess to form a pivot connection.

6. The illumination device as claimed in claim 2, wherein each of the pivoting shafts comprises a first shaft and a second shaft parallel to and connected to the first shaft, the first pivoting portion defines a first recess coupled to the first shaft for receiving the first shaft, and a second pivoting portion defines a second recess coupled to the second shaft for receiving the second shaft.

7. The illumination device as claimed in claim 1, wherein the plurality of illuminants are arranged in an array.

8. The illumination device as claimed in claim 7, further comprising a supporting member, and the illuminants are rotatably mounted on the supporting member.

9. The illumination device as claimed in claim 1, wherein the light source is selected from the group consisting of a light emitting diode, an incandescence lamp, a fluorescent lamp, an infrared ray lamp, a gas discharge lamp and a halogen lamp.

10. The illumination device as claimed in claim 1, wherein each of the illuminants comprises a heat sink device mounted on the casing for dissipating heat from the light source.

11. The illumination device as claimed in claim 10, wherein the heat sink device comprises a thermally conductive base mounted on the casing and a plurality of fins extending from the thermally conductive base.

12. An illumination device comprising:
a plurality of illuminants, each of the illuminants comprising a casing and a light source received in the casing; and
a plurality of connecting members interconnecting the casings, each of the connecting members being configured for pivotedly connecting two neighboring illuminants so that one of the two neighboring illuminants is rotatable relative to the other neighboring such illuminants.

13. The illumination device as claimed in claim 2, wherein each of the connecting members comprises a first shaft and a second shaft parallel to and connected to the first shaft, the casing comprises a first pivoting portion having a first recess coupled to the first shaft for receiving the first shaft, and a second pivoting portion having a second recess coupled to the second shaft for receiving the second shaft.

14. An light source assembly comprising:
a plurality of light source modules, each two neighboring light source modules pivotedly coupled to each other, each light source module having a light emitting surface, the light emitting surface of one such light source module being rotatable about a rotating axis relative to that of the other neighboring such light source module, the light emitting surfaces of the light source modules being arranged on a side of the light source assembly.

15. The light source assembly as claimed in claim 14, wherein one such light source module is slidable relative to the other neighboring such light source module along the rotating axis.

16. The light source assembly as claimed in claim 14, further comprising a supporting member, the plurality of light source modules being mounted on the supporting member, the light source modules being rotatable around an axis relative to the supporting member, the axis being substantially perpendicular to the rotating axis.

17. The light source assembly as claimed in claim 14, wherein the rotating axes are parallel to each other.

18. The light source assembly as claimed in claim 14, wherein each light source module includes a first light source unit, and a second light source unit, the second light source unit being linearly movable relative to the first light source unit.

19. The articulated light source assembly as claimed in claim 14, further comprising a plurality of pivoting members pivotedly interconnecting the light source modules.
